(19) United States
(12) Patent Application Publication
(10) Pub. No.: US 2015/0278969 A1
(43) Pub. Date: Oct. 1, 2015

(54) INTEGRATED AUTOMATED SOLUTION FOR THE MANAGEMENT OF SERVICES FOR THE DISABLED AND OTHERS

(71) Applicant: Xerox Corporation, Norwalk, CT (US)

(72) Inventors: Reeta J. Benoy, Rochester, NY (US); Eugene S. Evanitsky, Pittsford, NY (US)

(73) Assignee: Xerox Corporation, Norwalk, CT (US)

(21) Appl. No.: 14/225,771

(22) Filed: Mar. 26, 2014

(51) Int. Cl. G06Q 50/10; G06Q 10/00

(52) U.S. Cl. CPC G06Q 50/10; G06Q 10/00

(57) ABSTRACT

Methods and systems for managing services for disabled persons. A tracking database can be created and updated with information from a number of databases or with information based on an elapsed time. A smart tag can be issued to a disabled person upon request by processing and analyzing data contained in the tracking database. Information with respect to status of the smart tag can be viewed by enforcement authorities to detect the validity of the smart tag. The smart tag can be automatically activated or inactivated by mapping data from the tracking database to prevent fraudulent usage. The smart tag can be configured with a universal handicapped logo and a panic alert button for alerting a response service when the disabled person is in an emergency situation.

### FIELD OF THE INVENTION

Embodiments are generally related to the field of parking and service entitlement management. Embodiments are also related to transponder-based transportation and parking technologies including, for example, smart tags. Embodiments are additionally related to the management of services for the disabled.

### BACKGROUND

A handicapped permit, placard, or badge may be displayed in a parked vehicle by a person whose mobility would be otherwise significantly impaired by, for example, age, illness, disability or infirmity. A handicapped smart tag or placard can be configured as a placard or posted on a vehicle license plate, which permits an owner or operator of the vehicle to have special privileges regarding the parking of that vehicle including the privilege to park in a space reserved for persons with disabilities, a particular parking space (e.g., a time-limited space for a certain period of time), or to park at a meter without payment. Such reserved parking spaces can be allocated to disabled persons to minimize the distance they need to traverse to get to their destination.

Disabled persons (sometimes also referred to as differently abled persons) may not realize their eligibility for accessing handicapped parking spaces, or in some cases may not appreciate the fact their condition is debilitating enough to require a closer, handicapped parking space. They simply underestimate the benefit of closer parking and the time and energy it will save them to run errands, shop, attend physician appointments, travel, or participate in other activities without wearing themselves out within the first few minutes of arriving at their destination. Specialized license plates are provided for disabled parking; however, such license plates cannot be moved to other vehicles that might be employed to transport disabled person.

Conventionally managing rights, tags, and other items for the disabled person is now performed manually and is open to misuse and fraud. The abuse and/or misuse of disabled parking permits has been identified as a major problem with some estimates that the majority seen on the street are used or obtained fraudulently. The substantial privilege and convenience granted by such a permit provides a major incentive to use one illegally or obtain one fraudulently. Additionally, medical privacy laws often confound attempts to identify truly disabled individuals from those who are abusing such permits and tags.

The law is fairly restrictive to people entitled to these privileges. There are also a number of classes of users who can utilize some level of privilege, often for short periods of time. The number of people requiring such privileges is growing rapidly. Additionally, the disabled persons typically have to wait longer to apply for a handicapped smart tag or placard for their vehicle and such permits are easily copied or used inappropriately. Thus, present approaches to granting and managing handicapped placards and tags are inefficient, open to abuse, and time-consuming because the current system is manual with no real time validation of the status of disability of the patient

Based on the foregoing, it is believed that a need exists for an improved method and system for managing services for disabled persons. A need also exists for an improved disabled parking permit management method and system, as will be described in greater detailed herein.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved parking management methods and systems for disabled persons.

It is a further aspect of the disclosed embodiments to provide for an improved smart tag for issuance to disabled persons and for use in the management of vehicle parking.

The aforementioned aspects and other objectives and advantages can now be achieved as described herein. Methods and systems for managing services for a disabled person are disclosed herein. The disclosed embodiments describe an approach for uniquely identifying a disabled person and managing his or her disabled benefit entitlements by validating the status of diagnosis records, death records, palm ID, etc., thereby not allowing misuse of a disabled benefit tag (e.g., vehicle disabled tag).

With the disclosed methods and systems, authorities (e.g., provider, town, DMV, police, etc.) can access real-time data through a web-based Internet portal to enable enforcement. In some embodiments, a smart tag can be employed to authenticate the user and/or to communicate with a server to determine entitlements, and/or to record data indicatve of where and when the service was used (e.g., parking, building access, etc.)

In some embodiments, a tracking database (ORACLE, Microsoft, HBASE and the like) with respect to disabled persons can be created and updated directly by a medical staff and with information from a number of databases (e.g., patient data such as HICN number, diagnosis codes, death records, health information, DMV information, etc.) or based on an elapsed time. A smart tag can be issued to the disabled person upon request by processing and/or analyzing data contained in the database. Information with respect to the status of the smart tag can be viewed by, for example, an enforcement authority to detect or determine the validity of the smart tag from the illuminated display status.

The smart tag can be configured to be automatically activated/inactivated based on the information by mapping data from the tracking database to prevent fraudulent usage. The smart tag can include, for example, a universal handicapped logo and a button to alert a response service when a disabled person is in an emergency situation (e.g., sickness, dizziness, etc.) by offering a panic alert mechanism. Such an approach is thus useful for assisting eligible disabled persons to utilize their handicapped parking privileges for better management disabled parking and other related services.

The activation and deactivation of the smart tag can be automated by employing the tracking database. A HICN number, for example, may be employed to identify disablement and a particular category ID may light up based on the diagnosis code(s). Health information from a department of health and human service, for example, and other records (e.g., death records) can be employed to detect fraudulent usage. Thus, the smart tag can be inactivated based on the status of the health information data, which is connected to the tracking database.

In some embodiments, the smart tag can be configured in the context of an electronic wireless device with GPS (Global Positioning System) and an illuminated display capable of being remotely turned on/off for data communication. In other embodiments, the smart tag can contain biometric authorization components such as, for example, a palm identification unit for identifying disabled person and to prevent fraud via identity theft. The smart tag can thus be authenticated and a level of privilege can be displayed by querying the tracking database.

In other embodiments, the smart tag can be configured with particular colors and/or reflective portions (e.g., during the dark/night) to indicate disablement with respect to the user. The smart tag can also be configured as a reusable device. In such a situation, the user can be charged a particular amount and then when the device is returned, user can be reimbursed. In some embodiments, the smart tag can be refurbished/reinitialized for reuse after return. The smart tag further can be provided with a sticker having a QR (Quick Response) code, a bar code, or the smart tag may be equipped with OCR (Optical Character Recognition) software to extract text information from an image.

The tracking database further includes, for example, a medical practitioner record that already exists for an insurance purpose to determine if the person requires special parking and a particular duration of time. Direct contact with the particular medical practitioner indicated in the secure database can also be employed to validate the parking permit. The system can be extended to cover all types of reserved parking by changing a permit issuing validation logic. Such an approach employs existing database and direct connections to the patient's records and provides law enforcement officer to quickly validate the permit to reduce fraud. The system automates the issuing/renewing/cancelling lifecycle of the smart tag and provides a way to automatically verify the validity of the smart tag by the law enforcement officer to cut down on fraud and increase acceptance of the privileges.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a data-processing system, which can be implemented in accordance with an embodiment;

FIG. 2 illustrates a schematic view of a data-processing system that includes a service management module, an operating system, and a user interface, which can be implemented in accordance with one embodiment;

FIG. 3 illustrates an integrated automated system for the management of services for the disabled and others, in accordance with an alternative embodiment;

FIG. 4 illustrates a block diagram of a service management system, which can be implemented in accordance with an alternative embodiment;

FIG. 5 illustrates a high-level flow chart of operations illustrating logical operational steps of a method for managing services for a disabled person, in accordance with one embodiment;

FIG. 6 illustrates high-level flow charts or flow diagrams depicting example logical operational steps of additional methods for managing services for a disabled person, in accordance with another embodiment;

FIG. 7 illustrates an exemplary view of a smart tag that can be issued to a disabled person, in accordance with an embodiment;

FIGS. 8A, 8B, and 8C illustrate example database diagrams of a tracking database model, which can be implemented in accordance with an embodiment; and

FIGS. 9A and 9B illustrate a view of example health insurance claim number (HICN) prefixes and suffixes, in accordance with an embodiment.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As will be appreciated by one skilled in the art, the present invention can be embodied as a method, data processing system, or computer program product. Accordingly, the embodiments may take the form of an entire hardware embodiment or in all likelihood, an embodiment combining software and hardware aspects. Furthermore, embodiments or aspects thereof may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.). The computer program code, however, for carrying out operations of the present invention may also be written in conventional procedural programming languages such as the “C” programming language or in a visually oriented programming environment such as, for example, Visual Basic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (e.g., through the Internet utilizing an Internet Service Provider and/or Cloud-based technology). A preferred and likely embodiment typically utilizes both mobile and cloud technology. That is, most of the computing power will occur via a server within a Cloud-based network configuration (i.e., the “cloud”). Users will thus be able to interface to the services through Web service call or via Smartphone apps.

The embodiments are described at least in part herein with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

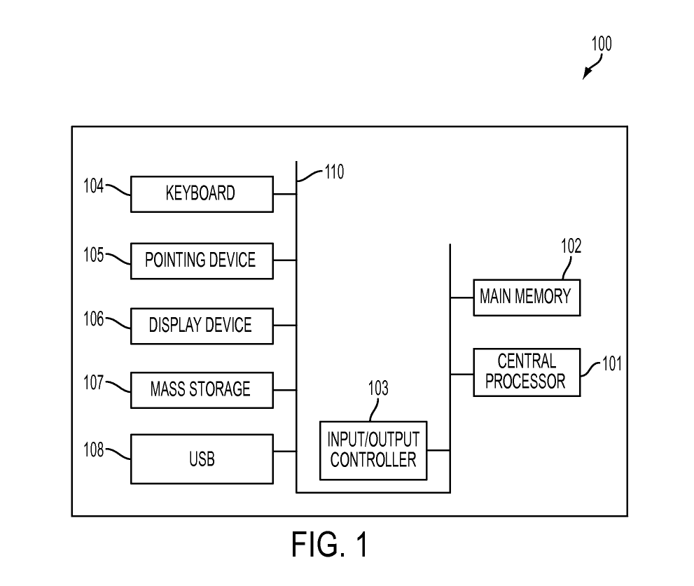

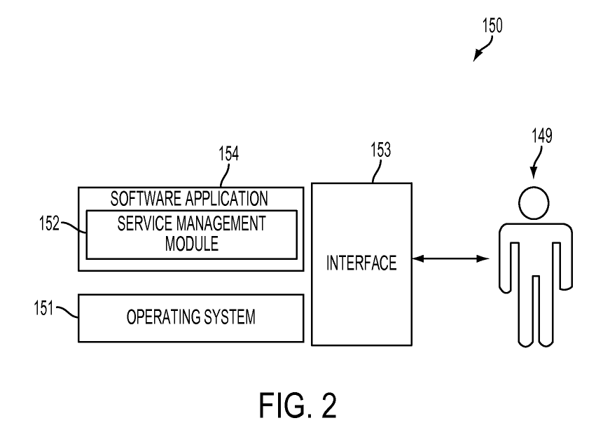

FIGS. 1-2 are provided as exemplary diagrams of data-processing environments in which embodiments of the present invention may be implemented. It should be appreciated that FIGS. 1-2 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

As illustrated in FIG. 1, the disclosed embodiments may be implemented in the context of a data-processing system 100 which can take the form of any number of computing devices such as, for example, a laptop computer, a desktop computer, a server, a Smartphone or tablet computing device, and so on In the embodiment shown in FIG. 1, system 100 can include, for example, a central processor 101, a main memory 102, an input/output controller 103, a keyboard 104, an input device 105 (e.g., a pointing device such as a mouse, track ball, and pen device, etc.), a display device 106, a mass storage 107 (e.g., a hard disk), and a USB (Universal Serial Bus) peripheral connection 108. As illustrated, the various components of the data-processing system 100 can communicate electronically through a system bus 110 or similar architecture. The system bus 110 may be, for example, a subsystem that transfers data between, for example, computer components within data-processing system 100 or to and from other data-processing devices, components, computers, etc.

FIG. 2 illustrates a computer software system 150 for directing the operation of the example data-processing system 100 depicted in FIG. 1. Software application 154, stored in main memory 102 and on mass storage 107, generally includes a kernel or operating system 151 and a shell or interface 153. One or more application programs, such as software application 154, may be “loaded” (i.e., transferred from mass storage 107 into the main memory 102) for execution by the data-processing system 100. The data-processing system 100 receives user commands and data through user interface 153; these inputs may then be acted upon by the data-processing system 100 in accordance with instructions from operating system module 152 and/or software application 154.

The following discussion is intended to provide a brief, general description of suitable computing environments in which the system and method may be implemented. Although not required, the disclosed embodiments will be described in the general context of computer-executable instructions such as program modules being executed by a single computer. In most instances, a “module” constitutes a software application.

Generally, program modules include, but are not limited to, routines, subroutines, software applications, programs, objects, components, data structures, etc., that perform particular tasks or implement particular abstract data types and instructions. Moreover, those skilled in the art will appreciate that the disclosed method and system may be practiced with other computer system configurations such as, for example, hand-held devices, multi-processor systems, data networks, microprocessor-based or programmable consumer electronics, networked PCs, minicomputers, mainframe computers, servers, and the like. For example, in some situations the data-processing system 100 described above may actually be a laptop computer or a hand held computing device such as a smartphone or tablet computing device.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task such as word processing, accounting, inventory management, etc.

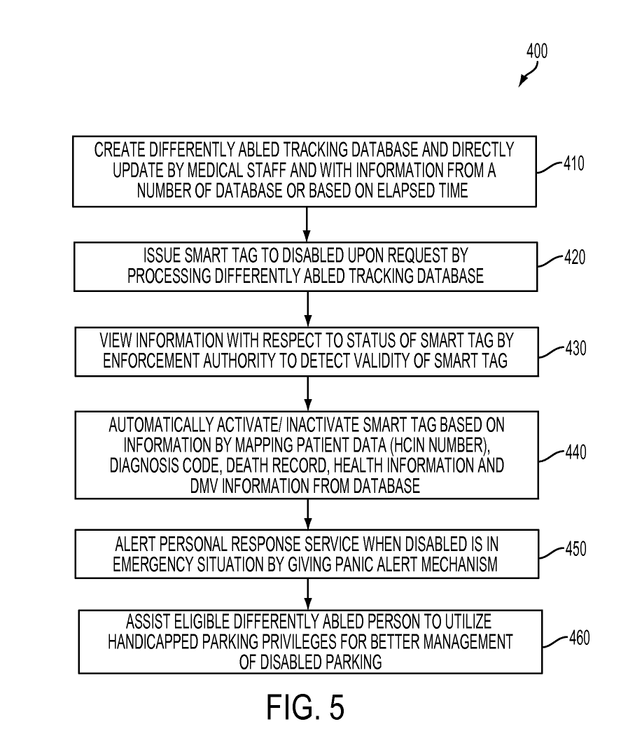

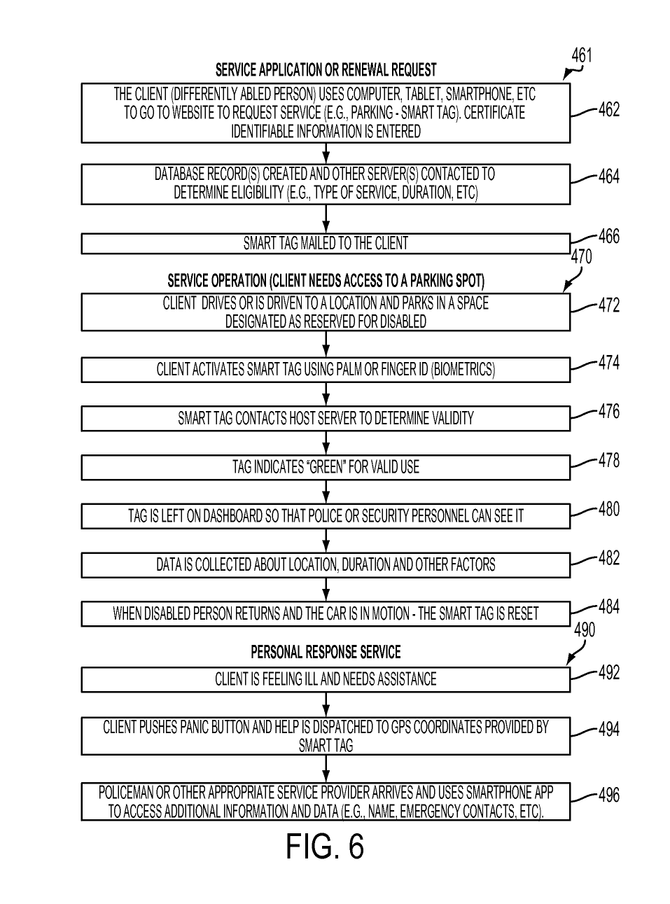

The interface 153, which is preferably a graphical user interface (GUI), also serves to display results, whereupon the user may supply additional inputs or terminate the session. In some embodiments, operating system 151 and interface 153 can be implemented in the context of a “Windows” or other operating system. In a mobile device, the operating may be, for example, the Android operating system, Apple operation system, and so on. It can be appreciated, of course, that other types of systems and components are possible. For example, rather than a traditional “Windows” system, other operating systems such as, for example, Linux may also be employed with respect to operating system 151 and interface 153. The software application 154 can include service management module 152 for managing services for a disabled person 385. Software application 154, on the other hand, can include instructions such as the various operations described herein with respect to the various components and modules described herein such as, for example, the methods depicted in FIGS. 5-6. Note that the term “differently abled” is preferred over disabled because this term covers a much larger range of special needs, For general illustrative purposes, however, the term “disabled” is primarily employed herein.

FIGS. 1-2 are thus intended as examples and not as architectural limitations of disclosed embodiments. Additionally, such embodiments are not limited to any particular application or computing or data-processing environment. Instead, those skilled in the art will appreciate that the disclosed approach may be advantageously applied to a variety of systems and application software. Moreover, the disclosed embodiments can be embodied on a variety of different computing platforms including Macintosh, UNIX, LINUX, HADOOP, Android, Apple iPhoneitablet and so forth.

It should be appreciated that the embodiments can be implemented in the context of varying elements or components. For example, the disclosed approach and system can be implemented in the context of a computing device such as a laptop computer, desktop computer, smartphone, tablet computing device, and so forth which can be utilized by a client to apply for or to renew the disabled parking privileges. The second context involves the use of terminals that health providers can access to add new data to the system. In a third embodiment or context, the hosted system can contain the logic (e.g., computer implemented instructions) necessary to interpret data to determine if the privilege is active. This entire system can be resident in the “cloud” rather than on a PC. The system can also be implemented as a Web service call.

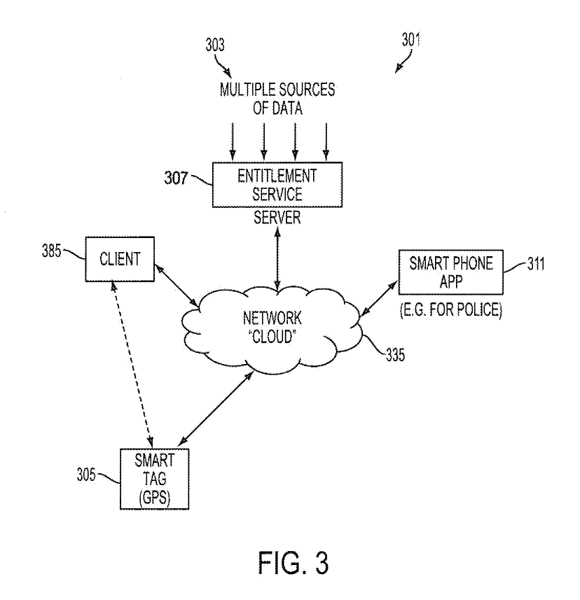

FIG. 3 illustrates an integrated automated system 301 for the management of services for the disabled and others, in accordance with an alternative embodiment. As indicated previously, the most likely or preferred embodiment involves the use of both mobile and cloud technology. Most of the computing power and data analysis will be accomplished via a server such as server 307 within or associated with the “cloud” or network 335. Users such as client 385 will thus interface to the services though a web service call or smart phone apps.

In general, there are four main components of system 301. The main component is an entitlement service 307 (e.g., server), which processes data 303 from multiple sources to determine if a service for a specific individual is currently active. Personal data is preferably not stored on this server. The client 385 (e.g., a differently abled person) can connect to the entitlement service via server 307 to apply for a smart tag 305 or to renew his or her request. The smart tag 305 can biometrically verify the identity of the disabled person or client 385 at the time the client wishes to use the service (e.g., park the vehicle they are driving or in which they are riding). The smart tag 305 is preferably equipped with GPS (Global Positioning Satellite) capability and can check in with a host server whenever necessary to determine if the tag is still active or if it has been re-activated. The tag 305 can be left in a vehicle (not shown in FIG. 3) when using a specially designated parking spot. An indicator light can be provided on the tag, which can be seen by, for example, a policeman or security guard. This will be a green indicator if the tag is valid or red if it is not. An optional 4^{th} component of system 301 can be a smartphone app 311 for a policeman or other personnel to retrieve data from the smart tag 305 such as the current status (i.e., if tag is not adequately visible due to snow, ice or dirt build up), the name of the disabled person, a designated driver, emergency contact, etc. That is, the policeman typically visually inspects the smart tag 305, which should indicate if parking is permitted or not. The smartphone “app” 311, however, can be provided to a police officer's smartphone to allow him or her to retrieve data from the smart tag 305 in case the tag 305 is not clearly visible.

Note that the term “cloud” as utilized herein refers generally to “cloud computing,” which is a computing paradigm that involves a large number of computers connected through a communication network such as the Internet, similar to utility computing. In science, cloud computing is a synonym for distributed computing over a network and means the ability to run a program or application on many connected computers at the same time.

Network-based services, which appear to be provided by real server hardware and are in fact served up by virtual hardware simulated by software running on one or more real machines are often called cloud computing. Such virtual servers do not physically exist and can therefore be moved around and scaled up or down on the fly without affecting the end user, somewhat like a cloud becoming larger or smaller without being a physical object.

In common usage, the term “the cloud” is essentially a metaphor for the Internet. Marketers have further popularized the phrase “in the cloud” to refer to software, platforms, and infrastructure that are sold “as a service”, i.e. remotely through the Internet. Typically, the seller has actual energy-consuming servers which host products and services from a remote location so end-users don't have to; they can simply log on to the network without installing anything. The major models of cloud computing service are known as software as a service, platform as a service, and infrastructure as a service. These cloud services may be offered in a public, private or hybrid network. Google, Amazon, Oracle Cloud, Salesforce, Zoho, and Microsoft Azure, for example, are some well-known cloud vendors.

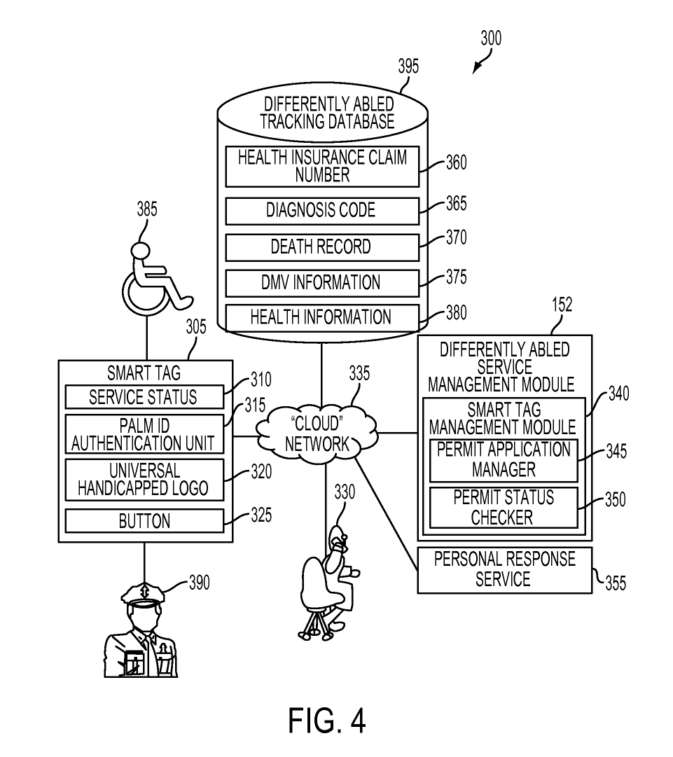

FIG. 4 illustrates a block diagram of a service management system 300, in accordance with an alternative embodiment. The system 300 shown in FIG. 4 is similar to system 301 albeit with some subtles differences. The service management system 300 depicted in FIG. 4 is generally capable of managing services with respect to a disabled person 385 (i.e., or a group of disabled persons). The service management system 300 can provide, for example, disability benefits to adults with a disability or a child with disability, based on a particular disability report. In general, a disabled person medical condition must meet the legal definition of a disability to qualify for a differently abled parking permit. The term “disabled” generally refers to a condition in which a person has, for example, severe visual impairment (e.g., usually visual acuity of 201200 or less), mobility problems (e.g., wheelchair confinement, lung or heart problems, arthritis, foot disorder, other medical conditions, etc.) that cause a person to use a brace, cane, crutch or other assistive device.

The differently abled service management system 300 generally includes the service management module 152 that is connected to a tracking database 395 via a network 335. The tracking database 395 can be created and updated directly by a medical staff/health care provider 330 or with information from a number of databases. The tracking database 395 includes patient data such as, for example, a health insurance claim number (HICN) 360, a diagnosis code 365, a death record 370, DMV (Department of Motor Vehicles) data 375, and health information 380 (e.g., Provider Information, Social Security Administration (SSDMF), and Centers for Medicare and Medicaid Services (CMS)). The tracking database 395 can also be updated based on an elapsed time.

It can be appreciated that variations to system 300 such as that of system 301 are possible. For example, systems 300 or 301 can be modified to provide data that can be processed to determine service eligibility. Death records, HICN, DMV, and other data be accessed separately and provided via the “cloud” network 335 and used to determine eligibility. In this situation, data such as HCIN 360, diagnosis code 365, death records 370, DMV information 375, and health information 380 may not be stored in database 395, but may be located elsewhere. System 301 shown in FIG. 3, for example, depicts just this situation where such data is not stored at server 307. Thus, it can be appreciated that a variety of implementations are possible and the dislcosed embodiments are not limited to the particular embodiments shown in FIGS. 3-4.

Note that the network 335 may employ any network topology, transmission medium, or network protocol. The network 335 or “cloud” may include connections such as wire, wireless communication links, fiber optic cables, and so on. Network 335 can also be an Internet representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational, and other computer systems that route data and messages.

The service management module 152 can be configured to include a smart tag management module 340 to issue a smart tag 305 to a disabled person 385 by processing the tracking database 395. The smart tag management module 340 further includes a permit application manager 345 and a permit status checker 350 to process request from the disabled person 385 for the smart tag 305 and provides status of request, respectively. A disabled parking permit, for example, can be provided in association with the smart tag 305, which is placed in the vehicle of the disabled person 385 so that the smart tag 305 is visible from the front and rear of the vehicle when parked in a designated disabled parking space. The smart tag 305 is hung from a support arm of the vehicle's rear view mirror.

An enforcement authority 390 can view information with respect to the status 310 of the smart tag 305 when a search is performed via, for example, a mobile communications device to detect the validity of the smart tag 305. That is, the smart tag 305 is associated with the person 385 rather than the person's vehicle. It can be appreciated that the smart tag 305 can also be utilized for other situations and is not limited to just parking. For example, the smart tag 305 can be employed for preferential seating on buses, plans, trains, in theaters, airport intra-terminal transportation, faster service, etc.

The smart tag 305 can be automatically activated/inactivated based on the information by mapping data from the tracking database 395 to prevent fraudulent usage. In some embodiments, the smart tag 305 can be equipped with a universal handicapped logo 320 and a button 325 that a user can press to send an alert to a personal response service 355 when the disabled person 385 is in an emergency situation (e.g., sickness, dizziness, etc.).

The activation and deactivation of the smart tag 305 can be automated by utilizing the tracking database 395 and the death record 370 can be employed to prevent fraud in any area. The HICN number 360 can be employed to identify disablement and the category ID can light up based on the diagnosis code 365. Health information 380 from department of health and human services can also be employed to detect fraudulent usage and the smart tag 305 can be inactivated based on the status of the health information 380. The validity from the smart tag 305 can be identified by linking to the patient data which is connected to the tracking database 395.

The tracking database 395 further includes the medical officer/health care provider 330 record that already exists for an insurance purpose to determine if the person requires special parking and duration. In some scenarios, direct contact from, for example, the medical officer 330 via the secure database access 395 can also be employed to validate the parking permit. The tracking database 395 can also be updated with, for example, obituary/death records 370 to prevent fraudulent usage. The system 300 can be extended to cover a vareity of types of reserved parking scenarios by altering the permit issuing validation logic. The system 300 thus assists eligible disabled person 385 to manage his or her parking privileges.

FIG. 5 illustrates a high-level flow chart of operations illustrating logical operational steps of method 400 for managing services for a disabled person, in accordance with an embodiment. It can be appreciated that the logical operational steps shown in FIG. 4 can be implemented via, for example, a module such as the module 152 shown in FIG. 2 and can be processed via a processor such as, for example, the processor 101 shown in FIG. 1. The tracking database 395 can be created and updated directly by, for example, medical staff 330 and with information from a number of other databases (e.g., patient data, HICN number(s) 360, diagnosis code(s) 365, death records 370, DMV information 375, health information 380, etc.) or based on an elapsed time, as shown at block 410. For example, a doctor indicates that a patient has a broken leg on a specific date and will require privileges for the next 8 weeks—after which time such privileges are automatically revoked. This can also be gleaned directly from the diagnostic code 365.

The smart tag 305 can be issued to the disabled person 385 upon request by processing or analyzing data contained in the tracking database 395, as indicated at block 420. Information with respect to the status of the smart tag 305 can be viewed by, for example, an enforcement authority 390 in order to detect the validity of the smart tag 305, as illustrated at block 430. The smart tag 305 can be automatically activated/inactivated based by mapping or analyzing data from the database 395, as depicted at block 440. The smart tag 305 can be configured in some embodiments with a universal handicapped logo 320 and a “panic” button 325. That is, in an emergency situation, the user can press the panic button 325 to send an alert to, for example, a personal response service 355, as shown at block 450. The eligible disabled person 385 thus can manage his or her handicapped parking services, as illustrated at block 460.

FIG. 6 illustrates high-level flow charts or flow diagrams depicting example logical operational steps of additional methods 461, 470, 490 for managing services for a disabled person, in accordance with another embodiment. The methods 461, 470, 490 shown in FIG. 6 represent example cases or situation. For example, method 461 involves the situation of a service application or renewal request. As indicated at block 462, the client (e.g., a differently abled person) can use a computer, tablet, smartphone, etc., to navigate to a website to request a particular service (e.g., parking—smart tag). Certain identifiable information is entered. Then, as shown at block 464, the system (e.g., system 300 or 301) can create a database record and can contact other servers to determine eligibility (e.g., type of service, duration, etc.). Thereafter, as depicted at block 466, the smart tag is mailed to the client.

Method 470 describes an example service operation such as the situation where the client needs access to a parking spot. As indicated at block 472, the client drives or is driven to a location and parks in a space designated as reserved for disabled. Next, as shown at block 474, the client can activate the smart tag using his or her palm or finger identification (e.g., biometrics). Thereafter, as illustrated at block 476, the smart tag is capable of contacting the host service to determine validity. Then, as depicted at block 478, the tag can indicate “green” for valid usage. Then, as shown at block 480, the tag can be left on the client's vehicle dashboard so that police or security personnel can see it. Thereafter, as depicted at block 482, data can be collected regarding location, duration, and other factors. Next, as shown at block 484, when the disabled person returns and his or her vehicle is in motion, the tag can be reset.

Method 490 provides an example of a personal response service. As shown in block 492, the client may be feeling ill and requires assistance. Then, as depicted at block 494, the client can push a “panic” button and help is then dispatched to the client's GPS coordinates provided by the smart tag. Thereafter, as illustrated at block 496, the policeman or other appropriate service personnel can arrive and use a Smartphone app (e.g., the app 311 shown in FIG. 3) to connect to a device (or service) for additional information—e.g., name, emergency contacts, etc.

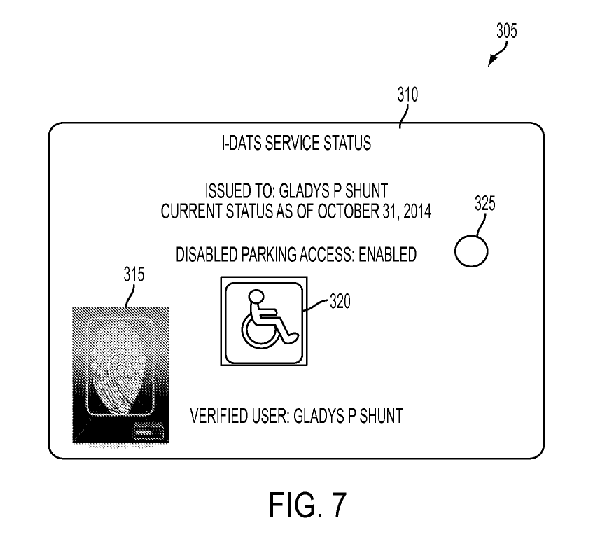

FIG. 7 illustrates an exemplary view of a sample smart tag 305 capable of being issued to a disabled person 385, in accordance with an embodiment. The smart tag 305 includes an electronic wireless device with GPS and an illuminated display that can be remotely turned on/off for data communication. The smart tag 305 further includes a palm identification unit 315 for identifying the disabled person 385 to prevent fraud through identity theft. In general, palm identity is an easy to use biometric solution to accurately ID healthcare patients. The patient's palm is digitally scanned which creates a unique digital signature that is attached to the digital medical record. Upon each visit the patient's hand is scanned linking that person to the correct chart.

The smart tag 305 can be authenticated and a level of privilege displayed in response to querying the database 395. The smart tag 305 can be configured with a particular color and/or reflective material (e.g., for the dark/night) to indicate disablement with respect to a particular user. The smart tag 305 can also be provided as a reusable device. In some situations, a fee may be assessed to the user when the smart tag is issued. The fee can be reimbursed, however, upon return of the item. For example, a charge of $5 can be charged when issued and when returned inactive, the user may be reimbursed the $5 charge. Once the smart tag 305 is returned it can also be refurbished/reinitialized for reuse. That is, the smart tag 305 can be refurbished/reinitialized for reuse after return. In some embodiments, the smart tag 305 can be equipped with a sticker having, for example, a QR code, or a bar code, or may be configured with OCR software to extract text information from an image.

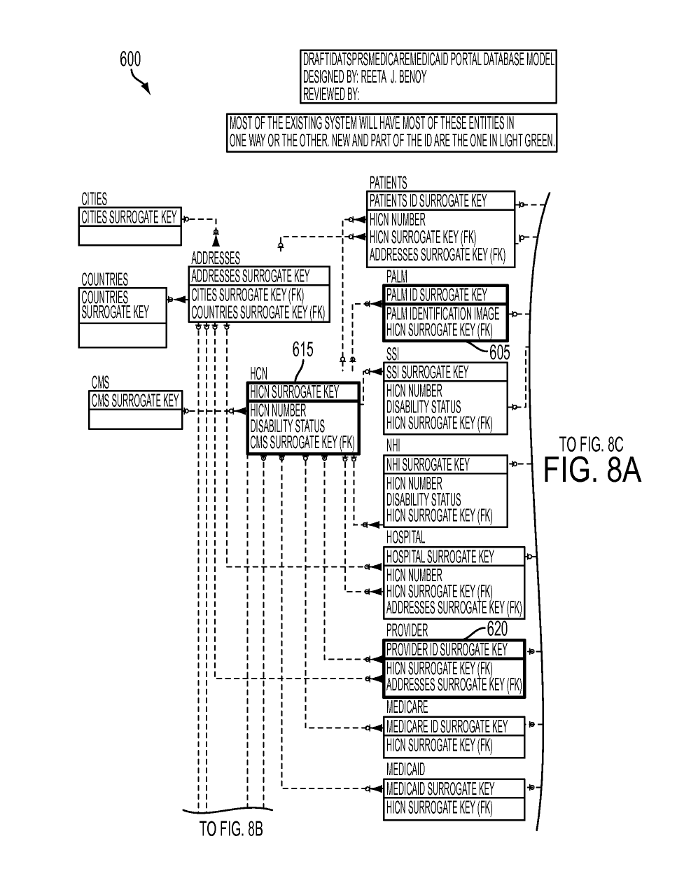

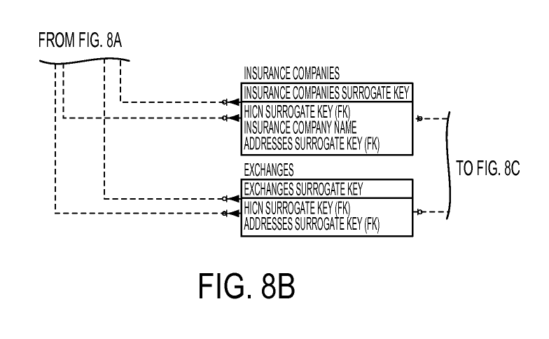

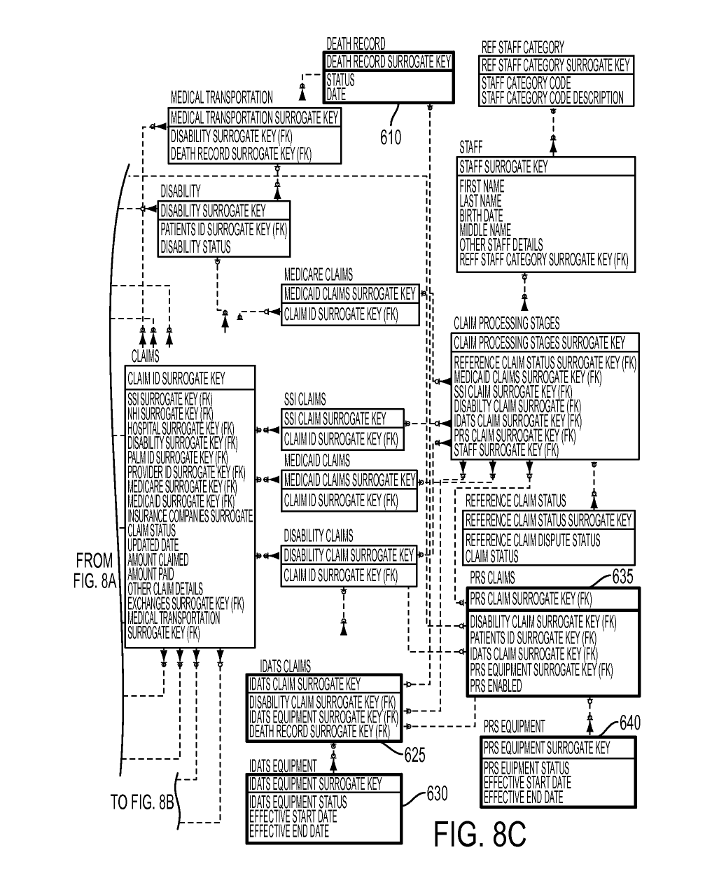

FIGS. 8A, 8B, and 8C illustrate a flow diagram 600 with respect to the tracking database model 395, in accordance with the disclosed embodiments. The tracking database model 395 includes a palm ID surrogate key 605, HICN surrogate key 615, provider ID surrogate key 620, IDATS (Intelligent Differently Abled Tracking Solution) claims surrogate key 625, IDATS equipment surrogate key 630, a claims surrogate key 635, equipment surrogate key 640, and death record surrogate key 610. The database 395 can also identify people required to support the disabled such as designated drivers.

The tracking database 395 need not retain private patient data, simply the entitlements data. A business intelligence solution can be designed for managing and reporting the tracking database 395. The system 300 can be employed for managing, for example, all social security users even if some have moved back to, for example, their country of origin or other locations. A variety of users and/or services can thus be tracked through the central tracking database 395. The activation and deactivation of the smart tag 305 can be automated utilizing the tracking database 395. With this approach, the systems 300 and/or 301 discussed and illustrated earlier thus can automatically activate/inactivate the smart tag 305 based on real-time integration of many systems and validation of the status of the disability of a patient (e.g., client 385) by uniquely identifying the patient.

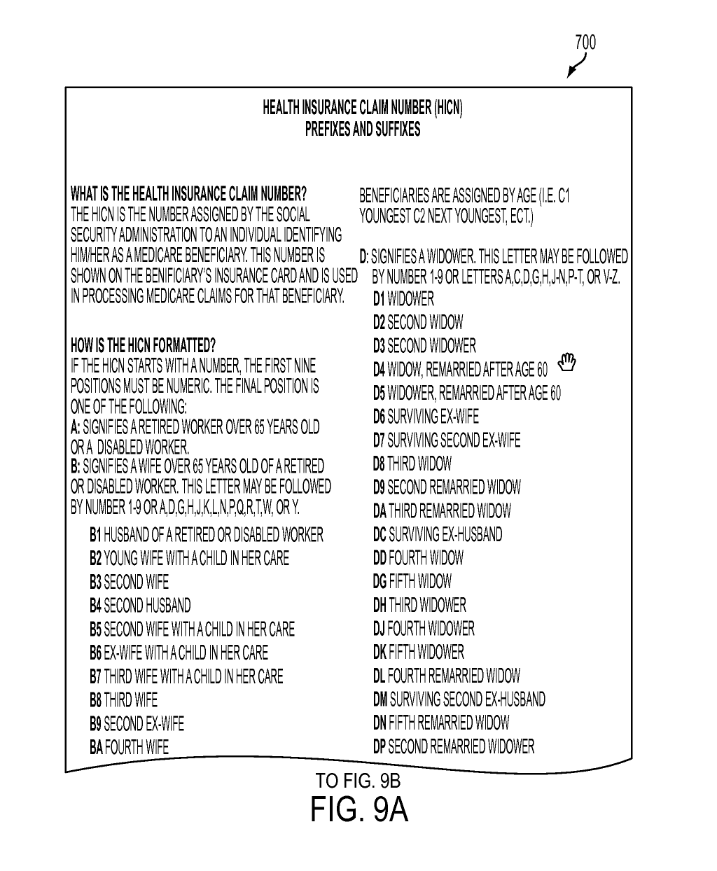

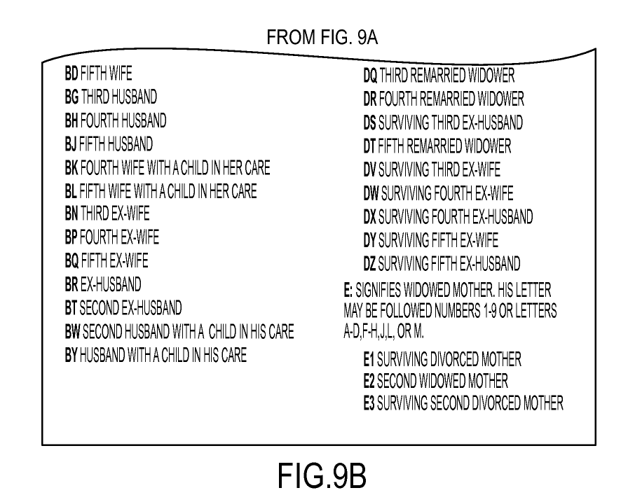

FIGS. 9A and 9B illustrate an exemplary view of a health insurance claim number (HICN) prefixes and suffixes 700, in accordance with the disclosed embodiments. Note that the acronym HICN generally refers to “Health Insurance Claim Number” which is the number assigned by the Social Security Administration to an individual for the purpose of identifying him/her as a Medicare beneficiary. The HICN may be shown in a beneficiary's insurance card and it is on this basis that a beneficiary's Medicare claims are processed. The HICN number 360 (or a similar number in other countries) can be employed to identify a person's particular disablement or simply the fact that a person is disabled.

In some embodiments, the mobile communications device “app” can be configured to read and interpret, for example, QR codes. The system 300 can manage the smart tags 305 and the tracking database 395 of patient entitlements. The system 300 provides an enhanced service to the disabled person 385 and manages data and sends alerts to users as well as database reporting. Such an approach employs existing databases and direct connections to the patient's records and provides law enforcement or other “authorities” with the ability to quickly validate, for example, a handicapped permit and reduce fraud. The system 300 automates the issuing, renewing, and cancellation lifecycle of the smart tag 305 and provides a technique for automatically verifying the validity of the smart tag 305.

Based on the foregoing, it can be appreciated that a number of embodiments are disclosed. For example, in some embodiments a database of entitlement can be created or configured and then updated directly by medical staff or with information from other databases or based on an elapsed time (e.g., a doctor indicates that the patient has a broken leg on a specific date and will require privileges for the next 8 weeks, after which time such privilegted are automatically revoked) or gleaned directly from patient diagnostic code. Obituary records (National Death Index and the like) can be employed to the database to prevent fraudulent usage. In some embodiments, a smart tag can be carried by a user, which can be employed to authenticate the user and verify and display the level of privilege to which they are entitled, and based on a query of the database.

Note that a person does not need to be ill to apply for the device. If that person is already entitled to use a disabled parking, the device will indicate so. The smart tag can be automatically activated/inactivated based on the information by mapping, for example, patient data (e.g., HICN Number, ICD 10 Diagnosis code, DMV information, etc.). Enforcement officers can also view the status in some embodiments. The database can also identify people needed to support the disabled such as designated drivers. The proposed system will manage the smart tags and the database of patient entitlements. The database does not need to retain private patient data, just the entitlements. This system will provide better service to the disabled.

Based on the foregoing, it can be appreciated that preferred and alternative embodiments are disclosed herein. For example, in one embodiment, an automated method for the management of services can be implemented. Such a method can include, for example, the steps or logical operations of associating an identifier with a person and one or more services unique to the person, authenticating the identifier with respect to the person to ensure proper authentication of the person and the service(s) unique to the person, and tracking data indicative of how the person utilized the service(s) for management of the service(s). In another embodiment, a step of logical operation can be provided for establishing an online portal to enable enforcement and management of the service(s). The identifier generally comprises a smart tag or another identifying component. The service may be, for example, a handicapped parking service, a disabled benefit entitlement or another service (e.g., preferred seating on buses, cars, in theaters, etc.).

In another embodiment, a step or logical operation can be implemented for associating a database with a server, wherein the database contains data associated the service and the person. In yet another embodiment, a step or logical operation can be provided for automatically activating or inactivating the smart tag in response to tracking the data in order to prevent fraudulent usage of the smart tag.

In another embodiment, an automated system for the management of services can be provided. Such a system can include, for example, a processor; a data bus coupled to the processor; and a computer-usable medium embodying computer program code, the computer-usable medium being coupled to the data bus. The computer program code can include instructions executable by the processor and configured, for example, for: associating an identifier with a person and one or more services unique to the person, authenticating the identifier with respect to the person to ensure proper authentication of the person and the service(s) unique to the person, and tracking data indicative of how the person utilized the service(s) for management of the service(s). In another embodiment, such instructions can be further configured for establishing an online portal to enable enforcement and management of the service(s).

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

1. An automated method for the management of services, said method comprising:
associating an identifier with a person and at least one service unique to said person;
authenticating said identifier with respect to said person to ensure proper authentication of said person and said at least one service unique to said person; and
tracking data indicative of how said person utilized said at least one service for management of said at least one service.

2. The method of claim 1 further comprising establishing an online portal to enable enforcement and management of said at least one service.

3. The method of claim 1 wherein said identifier comprises a smart tag.

4. The method of claim 1 wherein said at least one service comprises a handicapped parking service.

5. The method of claim 1 wherein said at least one service comprises a disabled benefit entitlement.

6. The method of claim 1 further comprising associating a database with a server, wherein said database contains data associated said at least one service and said person.

7. The method of claim 3 further comprising automatically activating or inactivating said smart tag in response to tracking said data in order to prevent fraudulent usage of said smart tag.

8. An automated system for the management of services, said system comprising:
a processor;
a data bus coupled to said processor; and
a computer-usable medium embodying computer program code, said computer-usable medium being coupled to said data bus, said computer program code comprising instructions executable by said processor and configured for:
associating an identifier with a person and at least one service unique to said person;
authenticating said identifier with respect to said person to ensure proper authentication of said person and said at least one service unique to said person; and
tracking data indicative of how said person utilized said at least one service for management of said at least one service.

9. The system of claim 8 wherein said instructions are further configured for establishing an online portal to enable enforcement and management of said at least one service.

10. The system of claim 8 wherein said identifier comprises a smart tag.

11. The system of claim 8 wherein said at least one service comprises a handicapped parking service.

12. The system of claim 8 wherein said at least one service comprises a disabled benefit entitlement.

13. The system of claim 8 wherein said instructions are further configured for associating a database with a server, wherein said database contains data associated said at least one service and said person.

14. The system of claim 10 wherein said instructions are further configured for automatically activating or inactivating said smart tag in response to tracking said data in order to prevent fraudulent usage of said smart tag.

15. A processor-readable medium storing code representing instructions to cause a process for the automated management of services, said code comprising code to:
associate an identifier with a person and at least one service unique to said person;
authenticate said identifier with respect to said person to ensure proper authentication of said person and said at least one service unique to said person; and
track data indicative of how said person utilized said at least one service for management of said at least one service.

16. The processor-readable medium of claim 15 wherein said code further comprises code to establish an online portal to enable enforcement and management of said at least one service.

17. The processor-readable medium of claim 15 wherein said identifier comprises a smart tag.

18. The processor-readable medium of claim 15 wherein said at least one service comprises a handicapped parking service.

19. The processor-readable medium of claim 15 wherein said at least one service comprises a disabled benefit entitlement.

20. The processor-readable medium of claim 17 wherein said code further comprises code to automatically activate or inactivate said smart tag in response to tracking said data in order to prevent fraudulent usage of said smart tag.
